(19) United States
(12) Patent Application Publication
(10) Pub. No.: US 2002/0130074 A1
(43) Pub. Date: Sep. 19, 2002

(54) Optical analysis of cellular material

(76) Inventors: Richard A. Domanik, Libertyville, IL (US); Peter P. Gombrich, Chicago, IL (US)

Correspondence Address: MERCHANT & GOULD PC, P.O. BOX 2903, MINNEAPOLIS, MN, 55402-0903, US

(21) Appl. No.: 09/981,285

(22) Filed: Oct. 15, 2001

Related U.S. Application Data
(60) Provisional application No. 60/240,186, filed on Oct. 13, 2000.
(60) Provisional application No. 60/240,247, filed on Oct. 13, 2000.
(60) Provisional application No. 60/240,244, filed on Oct. 13, 2000.
(60) Provisional application No. 60/240,472, filed on Oct. 13, 2000.
(60) Provisional application No. 60/240,248, filed on Oct. 13, 2000.

(51) Int. Cl. B01D 21/00

(52) U.S. Cl. 210/299

(57) ABSTRACT

A cellular sample can be optically analyzed while present on a membrane filter. A membrane filter is designed to collect and adhere cells and other cellular material while permitting fluids to pass. The cellular sample can be processed mechanically or manually in order to provide cells adhered to the membrane filter. The cellular sample can be obtained through lavage, by using a personal or physician's collector, or through traditional PAP test techniques. The cellular sample can include vaginal, cervical, or ovarian tissue cells.

### RELATED APPLICATIONS

This application claims the benefit under 35 USC § 119(e) of U.S. Provisional Applications Serial No. 60/240,186, entitled “OPTICAL ANALYSIS OF CELLULAR MATTER ON A MEDIUM”, Serial No. 60/240,247, entitled “TRIAGE DEVICE FOR OPTICAL ANALYSIS OF CELLULAR MATERIALS”; Serial No. 60/240,244, entitled “METHOD AND APPARATUS FOR OBTAINING AND ANALYZING CERVICAL TISSUE SAMPLES”; Serial No. 60/240,472, entitled “METHOD AND APPARATUS FOR OBTAINING AND ANALYZING OVARIAN TISSUE SAMPLES”; and Serial No. 60/240,248, entitled “CELLULAR SAMPLING VIA LAVAGE”; each of which were filed on Oct. 13, 2000, and each of which are incorporated in their entirety by reference herein.

### TECHNICAL FIELD

The invention relates generally to analyzing cellular material and relates more specifically to optically analyzing cellular material. In particular, the invention relates to capturing cellular material on a filter medium and optically analyzing the captured cellular material for indications of abnormality.

### BACKGROUND

Many forms of cancer can be successfully controlled or treated if the condition is detected sufficiently early in the development of the cancer. As a result, a number of screening tests and investigative methods have been developed. These include cytological procedures such as the PAP test and imaging modalities such as X-ray and ultrasound. However, optimal detection requires morphological examination of the tissue in question.

One example of a cancer with substantial cure rates if detected early enough is cervical cancer, which frequently begins as a precancerous lesion of the cervix. These lesions are also known as cervical intraepithelial neoplasia. If left untreated, these lesions can deepen over time and ultimately develop into an invasive cancer of the cervix and associated tissues. Fortunately, early detection followed by appropriate treatment results in a very high cure rate for cervical cancer.

Therefore, it is quite important that at least certain factions of the female population undergo regular screening. These factions include patients with previous cervical abnormalities and those who have a family history of cervical abnormalities. Women who are sexually active are at greater risk and should undergo regular screening, as are those who test positive for HPV (human papillomavirus). This is a sexually transmitted virus that in some forms can cause genital warts.

During the 1940's, Dr. George Papanicolaou developed a screening test which bears his name and which has become the most widely used screening technique for detecting abnormal cervical cells. Today, this test is known more commonly as the PAP test or the PAP smear test. Typically, the PAP test is performed in the physician's office as part of a woman's routine gynecological examination. The test involves collecting cervical cells via a brush, stick or swab that is used to loosen and then collect cells that can be examined microscopically.

Typically, the PAP test is performed by inserting a speculum into the patient's vagina to expose the cervix. The surface of the cervix is then scraped by a brush, stick or swab and the exfoliated cells thereby collected are smeared upon a microscope slide for cytological examination. Unfortunately, a technician who must view the slides so prepared is typically required, for cost-effectiveness, to review a large number of slides in a small period of time. Thus, accuracy can be negatively impacted. Moreover, a particular slide may contain only a very few cells of morphological interest and therefore can easily be overlooked.

Another disadvantage to the PAP test is the time required to obtain results. Typically, a patient may hear the results of her test several weeks after her gynecological examination. If the physician has concerns over the test results, the patient must schedule another visit to the doctor's office, which can be a financial and scheduling problem for the patient. Moreover, several weeks can be a long time to wait for a patient who, perhaps for family medical history reasons, believes that there may be a problem.

This can be a particular problem when conducting public health screenings as these circumstances it can be difficult to persuade an individual to come back several weeks later to learn of her test results, or to return if the test results reveal possible cervical cell abnormalities. Moreover, it can be difficult to even locate the patient once she has left the public health screening event.

Some cancers, such as ovarian cancer, can be difficult to detect and often times exhibit either vague or scarcely noticeable, or no symptoms at all during the early stages of the disease. Women who have an early stage of ovarian cancer generally do not have noticeable symptoms and therefore are not aware of the cancer and consequently do not seek medical attention. Typical symptoms of ovarian cancer include, for example, abdominal bloating or pressure, digestive problems, unusual vaginal bleeding, pelvic pressure and leg pain. Of course, these symptoms can be caused by a myriad of unrelated conditions, which makes diagnosis more difficult.

There are three general types of ovarian tumors, each named for the type of cell in which they begin. The most common form of ovarian tumor begins in the cells covering the surface of the ovary. These are called epithelial cells and thus the tumors are referred to as epithelial tumors. While most epithelial tumors are benign, it has been found that most ovarian cancers are epithelial in nature. The other two types of ovarian tumors each represent less than about five percent of ovarian tumors. These are germ cell tumors, which begin in the cells which ultimately become eggs, and stromal cell tumors, which begin in the tissue that holds the ovary together.

Typically, X-ray or ultrasound scans can be used to detect abnormal growths once the ovarian cancer has reached a particular stage at which the patient may exhibit overt clinical symptoms as previously described. Unfortunately, once the cancer has grown sufficiently to be detectable using conventional methods, the five year survival rate is less than 10 percent.

Fortunately, ovarian cancer has been found to have a relatively high survival rate if detected early enough. Often times, the cancer is detected incidental to an otherwise unrelated abdominal or gynecological surgery. It has been found that early detection of ovarian cancer leads to a five year survival rate of over 90 percent. However, less than about one-quarter of ovarian cancers are detected at this early stage. Thus, it is highly desirable to develop methods and techniques for reliable and early detection of ovarian cancer.

One possible answer is preventative screening, especially for women who have one or more risk factors. These risk factors include age, as about half of all ovarian cancers are found in women who are at least 65 years old. It has been found that extended use of some fertility drugs can increase the risk of ovarian cancer. Women who started menstruating before the age of 12, who have no children or did not have children before age 30, or who undergo menopause at a relatively old age, are at a greater risk. There appears to be a link between ovarian cancer and the total number of menstrual cycles a women undergoes. Breast cancer appears to increase the risk of ovarian cancer. Of course, any woman with a family history of ovarian cancer may also be at an increased risk of developing ovarian cancer herself.

Optimal detection requires morphological examination of ovarian tissue. Unfortunately, the ovaries are completely contained within the abdominal cavity and therefore are inaccessible without a relatively invasive surgical biopsy procedure such as a laparotomy (performed through an abdominal incision) or a laparoscopy (done through a lighted tube inserted into the pelvis).

A desire exists for a less invasive procedure for obtaining ovarian tissue samples for use in the detection and diagnosis of ovarian cancer. A desire exists for a way of obtaining ovarian tissue samples that can be performed on an outpatient basis, as well as for a way to rapidly analyze the sample to see if further examination is indicated.

A desire remains for a way to quickly and easily screen cellular samples. A desire remains for a device suitable for rapidly testing a cellular sample to determine if further testing is required.

### SUMMARY

The invention is directed to optically analyzing cellular materials present in a cell suspension to determine if further testing is required. The analysis can occur once the cellular material of interest has been captured on a membrane or filter. The cellular material can be examined optically by treating the cells with one or more reagents that preferentially causes abnormal cells to fluoresce. Alternatively, the cellular material can be examined optically through the use of a video microscope to visually inspect the cellular sample while in place on the membrane or filter. The cell suspension can be captured on the membrane or filter using either mechanical or hand processing.

Accordingly, an embodiment of the present invention can be found in a method of optically analyzing a cellular sample. A cell suspension is provided that includes cells that are suspended in a solution. The cell suspension is passed through a filter, thereby capturing cells on a surface of the filter. The captured cells are examined by analyzing the cells optically while the cells remain in place on the surface of the filter.

Another embodiment of the present invention is found in a triage device that is configured to capture cells found in a cell suspension. The triage device includes a sample well configured to hold the cell suspension, a membrane filter that is a thin plastic filter having pores that are sized to accommodate the cell suspension, a fluid flow control layer that limits fluid velocity, and a bulk absorbing layer. The cells can be optically analyzed while on a surface of the membrane filter.

Another embodiment of the present invention is found in a triage kit that is configured to capture and optically analyze cells found in a cell suspension. The triage kit includes a triage device as described above, as well as a volume of cell fixative and a reagent to preferentially indicate potentially abnormal cells.

Other features and advantages of the present invention will be apparent from the following detailed description and drawings.

### BRIEF DESCRIPTION OF FIGURES

FIG. 1 is a perspective view of a personal collector.

FIG. 2 is a perspective view of a physician's collector.

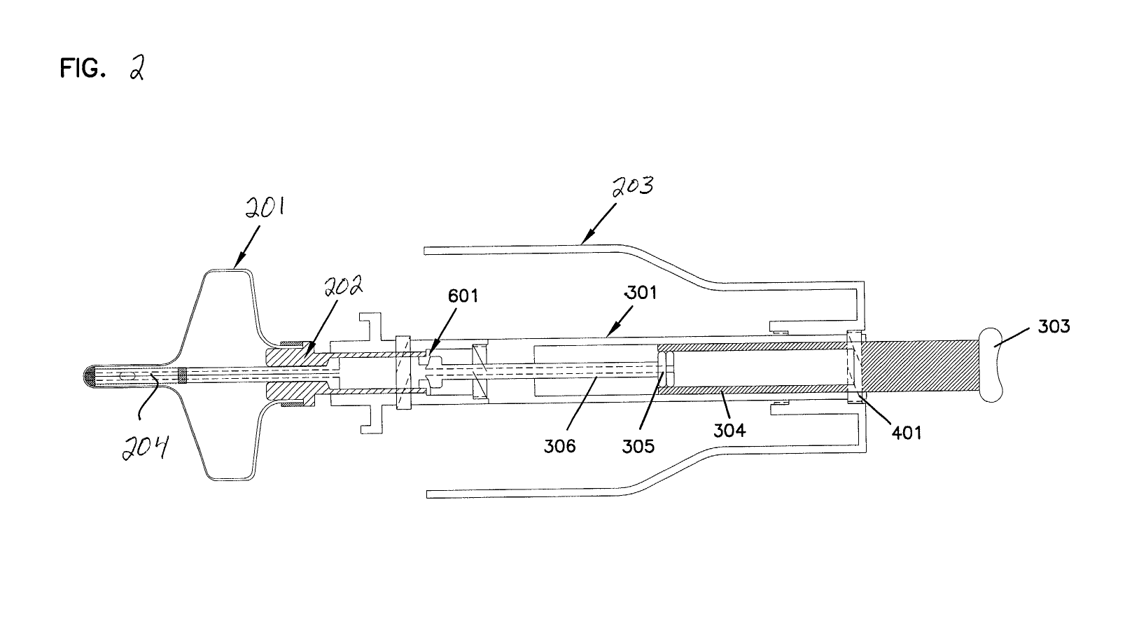

FIG. 3 is a schematic illustration of a triage device.

FIG. 4 is a schematic illustration of a tube and membrane filter assembly.

FIG. 5 is a schematic illustration of an alternate tube and membrane filter assembly.

FIG. 6 is a generalized view of the human female reproductive system, illustrating the relative position of the ovaries.

### DETAILED DESCRIPTION

A typical manner of processing and analyzing tissue samples such as cervical cell samples is to place the cells onto a microscope for morphological examination in which a technician examines the cells for visible signs of abnormality. If abnormalities or suspected abnormalities are found, additional testing of the patient may be required. This type of analysis is typical of the testing used to examine PAP smear samples, as is well known by those of skill in the art.

In addition to the traditional scrapping methods typified by the PAP test, cell samples can be obtained in other ways as well. For example, cervical and vaginal samples can be obtained using the personal cervical cell collector, which is described in U.S. Ser. No. 09/603,625, and which is expressed incorporated by reference herein. Another way to obtain cervical and vaginal cell samples is to use a lavage technique as described herein. Cervical cell samples can also be obtained using the physician's collector described in U.S. Ser. No. 09/725,332, which is expressly incorporated by reference herein.

Obtaining Cells via Personal Collector

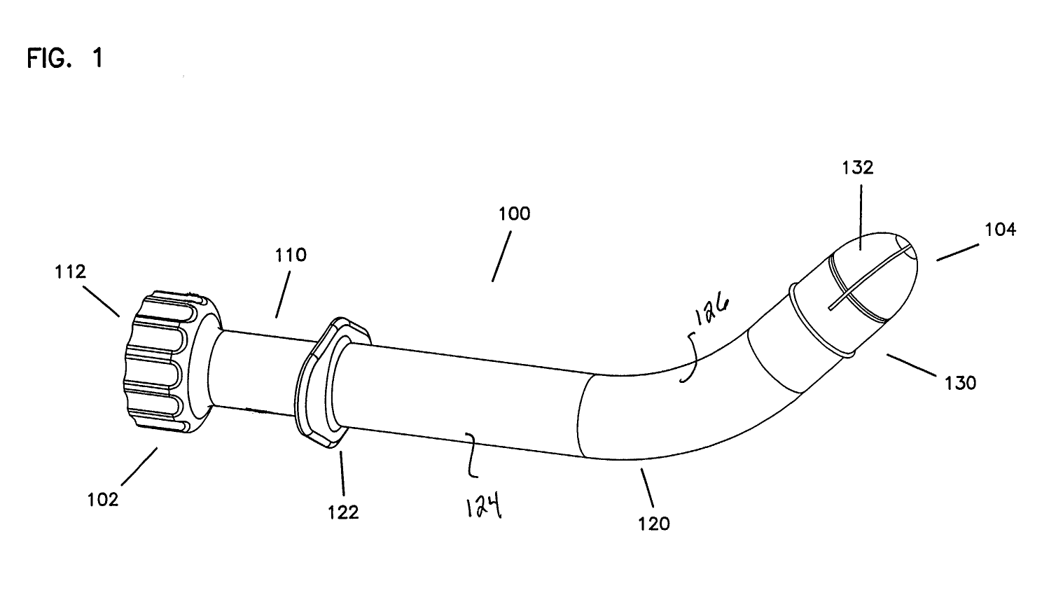

A way to obtain cellular material such as cervical and vaginal cell samples is to utilize a personal collector, as described herein with reference to the drawings. FIG. 1 shows a personal collector that includes an outer guide assembly 120 and an inner sampling assembly 110. A handle 112 is located at the proximal end 102 of the inner sampling assembly 110. In this, a proximal position is considered to be closest to the end of the personal collector 100 that remains outside the body (the handle) while a distal position is considered to be the opposite end, or the portion of the personal collector 100 that enters the body.

Outer guide assembly 120 is a hollow, substantially circular cylinder that can be curved to approximate the natural geometry of the vaginal tract when a woman is in a sitting or standing position, as these positions are more likely to be used by the woman in taking a cervical cell sample. While the outer guide assembly 120 can also be substantially linear, such a shape is more suited to the vaginal tract geometry obtained when the woman being examined is in the standard position for a gynecological examination.

The outer guide 120 also has a protective tip 130 located at the distal end 104 of the personal collector 100. The protective tip 130 protects the collector pad (not seen) during both insertion into and withdrawal (of the personal collector 100) from the user's vagina. The protective tip 130 can remove at least a portion of the mucus and other material typically found on and near the cervix. The protective tip 130 can be coated with or even be made from a substance that can function as desired. This can include cilia-like structures or fabric-like materials such as flocking.

The outer guide assembly 120 can include a finger grip 122 which, as described in greater detail hereinafter, provides assistance in positioning and operating the personal collector 100. Similarly, inner sampling assembly 110 has a handle 112 that will also be described in greater detail.

The handle 112 is located at the proximal end of the inner sampling assembly 110. The handle aids in operation of the personal collector 100. The handle 112 is seen as an enlarged portion of the smooth portion 114 of the inner sampling assembly 110. The handle 112 can be formed as an integral part of the smooth portion 114 or it can be formed separately and then adhered to the inner sampling assembly 110. The handle 112 as shown is scalloped, although a variety of other shapes and textures are possible. The handle 112, the rigid portion 114 and the flexible portion 116 are together considered to provide a grippable pusher that can be used to control the position of the collector pad.

Obtaining Cells via Physician's Collector

A way to obtain cellular material such as cervical and vaginal cell samples is to utilize a physician's collector, as described herein with reference to the drawings. The physician's collector includes a compliant cell sampling member 201 that is attached to an interface element 202 and that is mounted within a multifunctional container 203. A stylette 204 passes through the interface element 202 and into the cell sampling member 201 where it is bonded to the interior of the tip of the cell sampling member 201.

The sampling member 201 can be a balloon structure that is made of a suitable elastomeric material such as silicone rubber, latex rubber, polyurethane or a thermoplastic elastomer. Alternatively, the sampling member 201 can include a compliant solid body such as a graded density foam. For the balloon embodiment, the wall thicknesses and other parameters are controlled during fabrication to obtain a desired pliability.

When the container 203 is released from the interface element 202, it can be slid to the opposite end of the handle 301 where it is retained in position by mating latching features 401. These are illustrated schematically as a quarter turn right-hand threaded male-female fastener pair, although other retention means such as snap latches can be employed for this function. These mating latching features 401 are configured such that once the container 103 is secured to the handle 301, the container 103 assumes a predefined rotational orientation with respect to the folded sampling member 101.

Deployment is triggered partially by depressing the actuator button 303 at the end of the handle 301. The internal structure of the handle 301 can, in essence, be described as a syringe, the major elements of which consist of a barrel 304 that slides within the handle 301, an extension of which forms the actuator button 303; and a plunger 305 having an elongated hollow shaft 306 that is slideably retained in the body of the handle 301 and which makes air tight sliding contact with the interior of the barrel 304.

As the button 303 is initially depressed, friction between the plunger 305 and the barrel 304 causes the barrel 304, plunger 305 and hollow shaft 306 to move in unison in the direction of the sampling member 101 until the end 307 of the hollow shaft 306 makes contact with the inner portion of the interface element 103. This motion causes deployment of the sampling member into its unfolded state. Deployment ceases when the rear end of the stylette 204 seats against the inner surface of the inner portion of the interface element forming an air tight seal.

Selective expansion of portions of the sampling member is used to accommodate for the normal range of human variability and to perfect contact between the device and the cervix to which it is applied. This expansion is driven by the injection of air into the sampling member 201 and is controlled both but the wall thicknesses in the sampling member and by contact between the sampling member and the cervical tissue. Air is injected into the sampling member by means of the syringe structure incorporated into the handle 301.

Obtaining Cells Through Lavage

Cervical and vaginal samples can be obtained by washing the exterior surfaces of the cervix and/or the interior surfaces of the vagina with a suitable fluid in order to wash away exfoliated cells. The washing fluid is retrieved to capture the exfoliated cells. The washing fluid can be retrieved by pulling it through a filter, thereby causing the exfoliated cervical and vaginal material to be caught on a surface of the filter.

The sampling device described herein can take several forms, as it is its function that is important. The sampling device should be able to provide a sufficient volume of a cell collection fluid at a sufficient pressure to exfoliate enough cells to form a retrievable sample of adequate volume. The sampling device should be able to retrieve the cell collection fluid in a manner that limits contamination from other bodily fluids and that permits easy examination of the cells obtained.

The lavage sampling device can include a supply of cell collection fluid, a first channel through which the cell collection fluid can impinge on the tissue to be sampled, and a second channel through which the cell collection fluid can be collected. The second channel can be in fluid communication with a filter that can capture the collected cervical and vaginal cells and cellular matter and a vacuum source capable of drawing the cell collection fluid through the filter.

The first and second channels can be either adjacent to one another or can be concentric. The first and second channels can be arranged in concentric fashion as this arrangement provides for a minimum residence time for the cell collection fluid prior to being retrieved. Moreover, this arrangement is substantially less direction-sensitive than is an arrangement in which the first and second channels are located adjacent to one another.

The sampling device includes several components. In one embodiment, the sampling device includes at least one thin bore tube with a maximum diameter of about 3 millimeters through which cell collection fluid can pass. In another embodiment, the sampling device includes two thin bore tubes. One tube can be used to supply fresh cell collection fluid while the other tube can be used to retrieve spent collection fluid bearing the exfoliated cells of interest.

The thin bore tubing that supplies the cell collection fluid can have a nozzle at the distal end thereof. The nozzle serves to narrow the effective diameter of the tubing and thereby increase the pressure of the fluid exiting the nozzle and impinging on the ovary. Alternatively, the tubing itself can be configured with a diameter suitable to permit a sufficient liquid pressure within the tubing.

A source of suction can be used to help retrieve spent fluid bearing the exfoliated cells. A number of different suction or vacuum sources are known in the art and can readily be used with the apparatus described herein. Of course, it is important that the spent cell collection fluid be able to be captured.

Each of the thin bore tubes used to supply and retrieve cell collection fluid may include a valve or other proportioning means to control the volumetric flow rate through the sampling device. The sampling device can be as simple as merely including the two thin bore tubes. Alternatively, the sampling device can include a formed body (such as from bio-compatible plastic or surgical steel) that includes a nozzle for the supply tube. The sampling device can also be used as an aid for positioning the device via an imaging procedure such as X-ray or ultrasound. The formed body can more easily be seen and therefore can more easily and perhaps more accurately be positioned.

The sampling device can include several components. In one embodiment, a hypodermic syringe similar to that used to perform laproscopic procedures is used to penetrate into the abdominal cavity. Once an insertion has been made, a sampling device can be placed through the hypodermic needle. The sampling device can include at least one thin bore tube with a maximum diameter of about 3 millimeters through which cell collection fluid can pass. The sampling device can include two thin bore tubes. One tube can be used to supply fresh cell collection fluid while the other tube can be used to retrieve spent collection fluid bearing the exfoliated cells of interest.

The thin bore tubing that collects the spent cell collection fluid can be sized to enable sufficient collection volume while still being small enough to fit through the syringe and can be no more than about 3 millimeters in diameter. A source of suction can be used to help retrieve spent fluid bearing the exfoliated cells. A number of different suction or vacuum sources are known in the art and can readily be used with the apparatus described herein. Of course, it is important that the spent cell collection fluid be able to be captured.

The cell collection fluid can be supplied to the sampling device through any conventional fluid storage device. The fluid can be supplied via gravity such as an old-fashioned IV. Alternatively, the fluid can be supplied by manually compressing a supply line, or through the use of an electric pump. A variety of different types of pumps are known in the art, including peristaltic pumps.

As previously described, the collection fluid can be heated prior to use. A supply of cell collection fluid can be heated prior to attachment to the sampling device, i.e. a plastic container of saline can be heated in a microwave. Alternatively, the fluid can pass through an electric or hot water heater as the fluid is being transported into the sampling device, i.e. the thin bore tubing can pass through a heat exchanger.

Once the cell collection fluid has been retrieved, it can be drawn through a filter that is configured to retain and adhere any cellular material present within the cell collection fluid.

The sampling device can be used to supply the cell collection fluid. While saline can be used as the cell collection fluid, any other biocompatible fluid could also be used. In this, a biocompatible fluid is defined as a fluid that neither negatively impacts the internal tissues of the body nor is itself effected by bodily tissues and fluids.

The cell collection fluid can be heated to a temperature close to normal body temperature (37° C.). While it is not necessary to heat the cell collection fluid, it has been found that heating the fluid increases the comfort level for the patient as well as reducing the likelihood of shocking the patient (as would be possible with a unheated cell collection fluid).

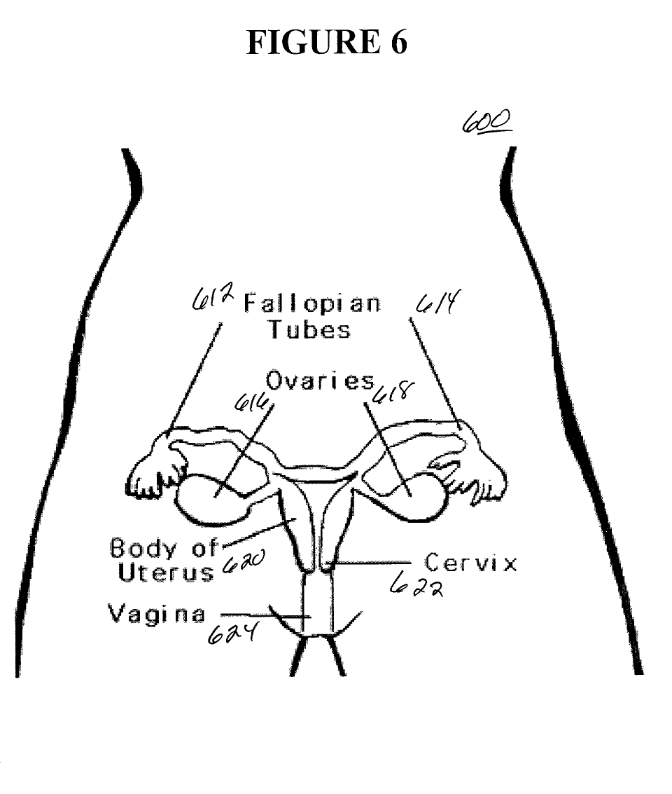

FIG. 6 illustrates the placement of the ovaries 616, 618 within a woman 600. The vagina 624, uterus 620 and cervix 622 are shown to assist in locating the ovaries 616, 618. The ovaries 616, 618 are located near the fallopian tubes 612, 614, respectively.

The procedure begins by making a small incision through either the abdominal or vaginal wall. A local anesthetic can be applied to the incision site prior to making an incision. If the incision is made through the abdominal wall, the incision be made along the abdominal midline. Such an incision permits access to both ovaries through a single incision. Alternatively, a vaginal wall incision makes simultaneous washing and cell collection fluid recovery easier.

The sampling device can be used to supply the cell collection fluid. While saline is preferred as the cell collection fluid, any other biocompatible fluid could be used. In this, a biocompatible fluid is defined as a fluid that neither negatively impacts the internal tissues of the body nor is itself effected by bodily tissues and fluids.

The sampling device can be guided into position through the use of imaging techniques such as ultrasound imaging, X-ray, MRI or CT scans. These techniques are well known to those of skill in the art. Once the sampling device has been positioned, the cell collection fluid is introduced into the abdominal cavity. The cell collection fluid can pass through the sampling device in such a way as to impinge on the ovary. This washes exfoliated cells into the cell collection fluid. The sampling device can be moved around the ovary 616, 618 in such a way as to be able to wash all or nearly all of the surface of the ovary 616, 618. Sampling accuracy improves as more of the ovary is sampled.

If necessary, the washing step can include an agitation step to increase the rate of cell exfoliation. Agitation can be created by a number of different mechanisms, such as ultrasonic cavitation, pulsating flow, turbulent flow and other methods well known to those of skill in the art. Several different agitation techniques can be combined to obtain a desirable number of exfoliated cells.

In the washing step, a first ovary 616 is washed and the fluid recovered prior to washing the second ovary 618. In this, the reference numerals 616 and 618 refer to first and second, rather than to left and right. This process has the advantage of possibly being able to identify which cells came from the first ovary 616 and which came from the second ovary 618. Further, it has been found that by simultaneously washing the ovary and collecting the cell collection fluid, the collection of non-ovarian tissue cells can be minimized.

The cell collection fluid, now bearing the exfoliated ovarian tissue cells, is withdrawn from the abdominal cavity. Preferably, the fluid is withdrawn through the sampling device. It is preferred that the cell collection fluid be withdrawn as the ovary 616, 618 is being washed. This minimizes the amount of non-ovarian cells collected.

Further, it is contemplated that a surgeon can employ the sampling methods and apparatus of the invention in sampling tissues made reachable by traditional invasive surgical procedures. For example, a surgeon can perform a simple appendectomy and can obtain cellular samples from other abdominal organs without requiring an additional or larger incision. Examples of such organs include the stomach, liver, spleen, intestines, uterus and ovaries. The invention described herein can be applied to obtaining tissue samples from a variety of mammals, including canine, feline, equine, porcine and human.

Manual Processing

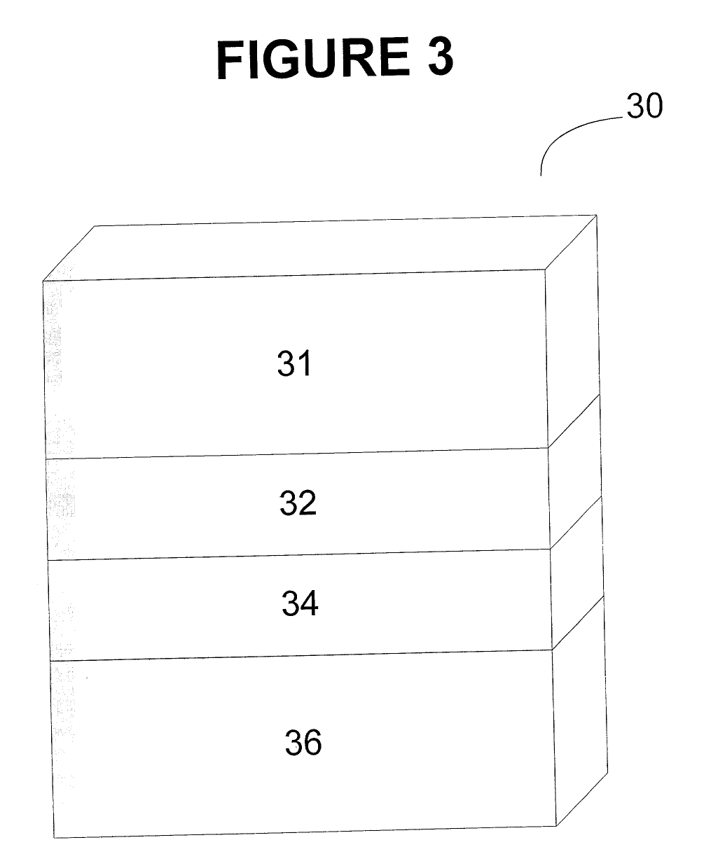

The triage device described herein is intended to provide a simple, rapid means of determining whether a cellular sample should be referred for further, more detailed cytological evaluation. In a preferred embodiment, the triage device provides a simple, rapid means to determining if a cervical sample warrants further examination. The triage device is best explained in reference to FIG. 3, which schematically illustrates a particular embodiment of the invention.

FIG. 3 show a triage device 30 having a membrane filter 32 that can be positioned over a flow control layer 34. As will be discussed in greater detail hereinafter, the flow control layer 34 limits fluid velocity through the triage device 30 to ensure more complete wetting of the membrane filter 32 and to ensure better reaction kinetics during use of the triage device 30. A bulk fluid absorber layer 36 is positioned under the flow control layer 34 to capture most or all of the fluids that pass through the upper layers of the triage device 30. For ease of use, a sample well 31 is provided atop the membrane filter 32.

The membrane filter 32 can be a thin plastic filter having pores that are sized in accordance with the particular cellular material of interest, as well as the identity and physical properties of the cell collection fluid and various reagents used to process the cellular material on the filter 32. For screening cervical and vaginal cells and related cellular material, a filter having pores about 5 to 10 microns in diameter is useful. Suitable filters are available commercially under the NUCLEOPORE™ and ISOPORE™ brand names.

The fluid control layer 34 can be selected to provide a desired volumetric flow rate of cell collection fluid and other reagents and solvents through the triage device 30. An example of a suitable fluid control layer 34 is high density filter paper having a thickness of about 1 millimeter. The flow rate can be adjusted, for example, to account for the viscosity of the sample, by using different materials for the fluid control layer 34. If a substantially slower flow rate is desired, for example, a nonwoven synthetic such as that available commercially under the TYVEK™ name can be used. These materials are generally hydrophobic, which will reduce the flow rate of aqueous-based solutions and suspensions through the triage device 30.

The bulk fluid absorbent layer 36 is used to absorb any and all fluids that pass through the upper layers of the triage device 30. The bulk fluid absorbent layer 36 can be selected and sized such that it can absorb all fluids that are placed on the triage device 30 without becoming saturated as the absorbent layer 36 is relied upon in particular embodiments to provide, along with gravity, at least part of the driving force that ensures fluid flow through the triage device 30. Thus, the absorbent layer 36 can be formed from any suitable blotter or absorbent material.

Fluid flow through the triage device 30 also can be accomplished mechanically. In an alternate embodiment, a source of vacuum can be provided in fluid communication with a lower surface of the fluid control layer 34, thereby providing both a driving force to ensure fluid flow through the triage device 30 and a means to capture the fluid. In yet another embodiment, centrifugal force can be used to drive various fluids through the triage device 30.

The triage device 30 can be formed in a variety of geometric configurations and certainly is not limited to the cube-like geometry shown in FIG. 3. The triage device 30 and each of the layers 32, 34 and 36 can also be circular or any other configuration that aids in the manufacture and use of the triage device 30. In a particular embodiment, the triage device 30 and each the layers 32, 34 and 36 are circular. In this embodiment, the sample well 31 can be cylindrical in shape and has a height sufficient to provide the fluid holding capacity necessary for use.

The triage device 300 can be used to analyze virtually any cell suspension. This can include analysis of menstrual fluid, urine, sputum and various lavage samples. The cell suspension can have a viscosity that is about equal to that of water. If the cell suspension is substantially more viscous than this, it can be diluted to a desired viscosity level. Alternatively, various chemicals are known that can substantially reduce the viscosity of a cell suspension without significantly diluting the suspension.

The collection device is placed in a vial of liquid base preparation and the vial is sonicated or agitated to release the cells from the sampling device into the solution. In a particular embodiment, this can be achieved simply by swishing the vial by hand. Thus. a cell suspension bearing the cells of interest is obtained and a volume thereof is transferred to the triage device 30.

The volume necessary can vary substantially, depending on the cell suspension being analyzed. It has been determined that capturing about 10,000 to about 20,000 cells within about a 6 millimeter spot on the membrane filter 32 provides a useful sample. As one of skill in the art will realize, the physical dimensions of the triage device 30 will depend in large part on the properties of the particular cell suspension being analyzed.

Specifically, the volume of cell suspension is transferred into the sample well 31, where the cells are allowed to settle across the membrane. Flow through the membrane 32 will increase as the membrane 32 becomes fully wetted. Once the membrane 32 has been fully wetted, fluid flow through the membrane 32 will remain essentially constant. All of the fluid that passes through the membrane 32 and the flow control layer 34 can be absorbed in the bulk fluid absorbing layer 36, or the bulk fluid absorbing layer 36 can absorb less than all of the fluid.

If desired, an aliquot of a cell conditioning fluid is dispensed onto the membrane 32 and is drawn through the membrane 32 by the fluid control layer 34 and the bulk fluid absorbing layer 36. It has been found that the use of a cell conditioning fluid may be optional. If used, the cell conditioning fluid can be a combination of buffers, detergents and various proteins. The cell conditioning fluid washes, permeabilizes and blocks the cells.

Next, an aliquot of staining reagent is dispensed onto the membrane 32 and is also drawn through the membrane 32 by the layers 34, 36 beneath it. The residence time required by the staining reagent is achieved by controlling the fluid volume and volumetric flow rate through the membrane 32. This is done in part by the fluid control layer 34 and the bulk fluid absorbent layer 36. The reaction conditions can be such as to ensure saturation kinetics.

The staining reagent can be a single chemical or a mixture of several chemicals. In a particular embodiment, the staining reagent is a mixture of 4 or 5 distinct chemicals. These individual reagents can be delivered simultaneously as a mixture or can be delivered sequentially. The staining reagent or reagents are selected such that they will bind selectively to abnormal cells and will fluoresce at a level greater than that achieved or observed for normal cells.

While a single staining reagent containing a single molecule can be used, it is recognized that a multi-step staining reagent also can be used. For example, the first step can consist of providing a targeting moiety that binds selectively to abnormal cells. The targeting moiety can be an antibody. The next step can include providing a reagent that will bind to the targeting moiety and will cause the abnormal cells to provide an elevated fluorescence level. Alternatively, the staining reagent can be selected such that the target abnormal cells will exhibit a change in luminescence or even in absorbance.

A wash solution is dispensed onto the membrane 32 and is drawn through by the bulk fluid absorber layer 36. The wash solution is intended to remove any remaining stain reagents and can contain a variety of buffers, detergents and salts. If, for example, the membrane 32 is neutral, a wash solution containing more detergents can be effective in washing any excess stain reagents from the membrane 32 and from the cellular material found thereon. Conversely, if the membrane 32 is either charged or has polar substituent groups (such as a NYLON™ membrane), a wash solution containing more salts will be effective.

Next, a stabilizing reagent is dispensed onto the membrane 32 and is drawn through the triage device 30. The stabilizing reagent serves as a fixative to keep the cellular material in place on the membrane 32. While a variety of stabilizing reagents can be used and are known to those of skill in the art, it has been found that a solution of polyethylene glycol (PEG) in isopropanol is useful.

The triage device 30 can also utilize various calibration and control chemicals, and can be provided with calibration chemicals that can be used to calibrate whichever instrument is being used to optically analyze the cellular material placed on the membrane 32. Moreover, it can be beneficial to provide controls that can demonstrate whether or not the chemistry involved in preparing the cellular sample has functioned correctly.

The staining reagent can be selected as a reagent that causes abnormal cervical cells to fluoresce. Once the triage device 30 has been processed as described herein, the triage device 30 can be scanned to detect the presence and level of fluorescence present in the cells captured on the membrane 32. If the detected fluorescence is below a particular threshold, the sample is deemed normal. If the detected fluorescence is substantially above the threshold, the sample is believed to be abnormal and is tagged for diagnostic cytology examination. Finally, if the sample reads near the threshold, the sample is equivocal and is also referred for diagnostic cytology evaluation.

Alternatively, once the membrane 32 has been loaded with cellular material, it can also be examined optically by using, for example, a video microscope to visually inspect the sample. This is of course well known to those of skill in the art.

Mechanical Processing

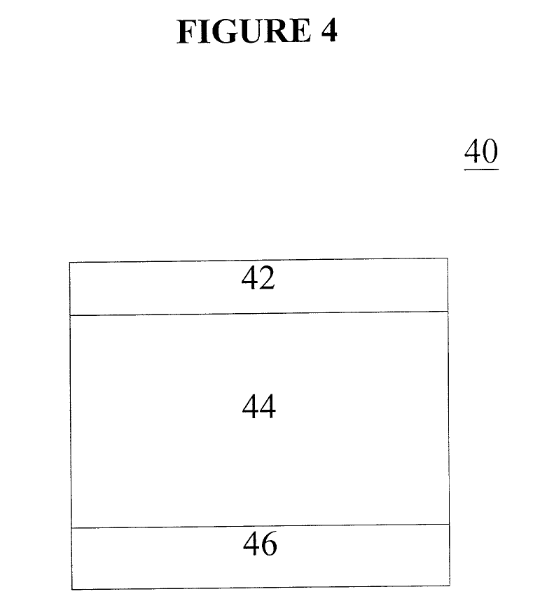

Cell suspensions can also be processed mechanically. Suitable mechanical processing is described for example in U.S. Pat. Nos. 5,143,627 and 5,240,606, each of which are explicitly incorporated by reference herein. FIG. 4 shows a testing apparatus 40 that includes a membrane filter 42 secured to one end of a tube 44. A drain or vacuum port 46 is provided at the other end of the tube 44 to provide a connection to the driving force necessary to pull cell suspension fluid and various reagents through the membrane 42.

The membrane 42 can be a thin plastic filter having pores that are sized in accordance with the particular cellular material of interest, as well as the identity and physical properties of the cell collection fluid and various reagents used to process the cellular material on the membrane 42. For screening cervical and vaginal cells and related cellular material, a filter having pores about 5 to 10 microns in diameter is preferred. Suitable filters are available commercially under the NUCLEOPORE™ and ISOPORE™ brand names.

To obtain a cell suspension, the collection device can be placed in a vial of liquid base preparation and the vial can be sonicated or agitated to release the cells from the sampling device into the solution. In a particular embodiment, this can be achieved simply by swishing the vial by hand. Thus, a cell suspension bearing the cells of interest is obtained and a volume thereof is transferred to the apparatus 40.

In use, the tube 44 is lowered into a volume of cell suspension so that the membrane filter 42 is in fluid communication with the cell suspension. Application of vacuum to the drain or vacuum port 46 pulls the cell suspension fluid through the filter 42, with the cells caught on a surface of the filter 42.

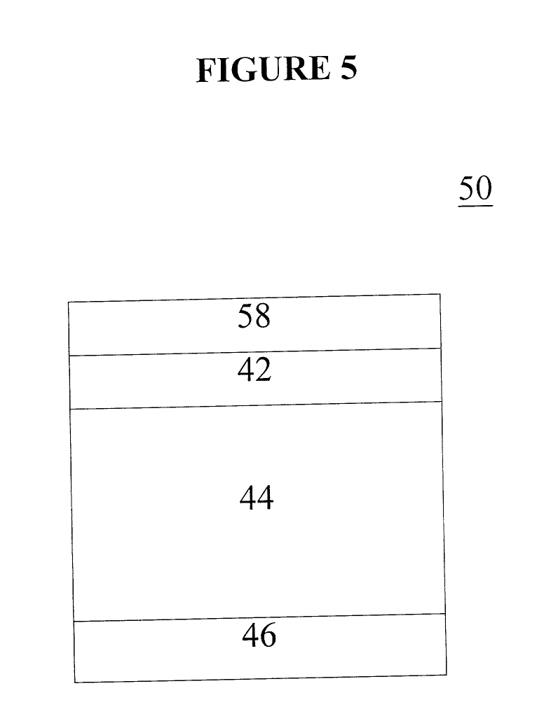

Alternatively, the tube 44 can include a ring-shaped bezel that forms a chamber above the membrane 42 that is suitable to hold an adequate volume of any fluid being pulled through the membrane 42. This is seen as chamber 58 in FIG. 5. Thus, it is not necessary to move the tube 44 in order to contact the membrane 42 with various fluids and reagents.

Once the cells have been caught on the membrane 42, the cells are contacted by various reagents in a similar manner. As the cells are held immobile on the membrane 42, the tube 44 can be lowered into volumes of various reagents such that the membrane 42 is brought into fluid communication with each volume. Application of vacuum at drain or vacuum port 46 pulls the particular reagent through the filter 42, thereby wetting the cells with the reagent. As noted, the various reagents can instead be placed in chamber 48.

A stabilizing reagent can be applied to the cells caught on the membrane 42. The stabilizing reagent serves as a fixative to keep the cellular material in place on the membrane 42. While a variety of stabilizing reagents can be used and are known to those of skill in the art, it has been found that a solution of polyethylene glycol (PEG) in isopropanol is preferred.

If desired, a cell conditioning fluid can be pulled through the membrane 42. It has been found that the use of a cell conditioning fluid may be optional. If used, the cell conditioning fluid can be a combination of buffers, detergents and various proteins. The cell conditioning fluid washes, permeabilizes and blocks the cells.

Next, the cells held on the membrane 42 are contacted with a staining reagent. The residence time required by the staining reagent is achieved by controlling the fluid volume and volumetric flow rate through the membrane 42. This is done in part by controlling the pressure drop across the membrane 42 provided by the vacuum source.

A wash solution is then pulled through the membrane 42. The wash solution is intended to remove any remaining stain reagents and can contain a variety of buffers, detergents and salts. If, for example, the membrane 42 is neutral, a wash solution containing more detergents can be effective in washing any excess stain reagents from the membrane 42 and from the cellular material found thereon. Conversely, if the membrane 42 is either charged or has polar substituent groups (such as a NYLON™ membrane), a wash solution containing more salts will be effective.

The apparatus 40 can also utilize various calibration and control chemicals. Preferably, the apparatus 40 is provided with calibration chemicals that can be used to calibrate whichever instrument is being used to optically analyze the cellular material placed on the membrane 42. Moreover, it can be beneficial to provide controls that can demonstrate whether or not the chemistry involved in preparing the cellular sample has functioned correctly.

The staining reagent can be selected as a reagent that causes abnormal cervical cells to fluoresce. Once the membrane 42 has been processed as described herein, it can be scanned to detect the presence and level of fluorescence present in the cells captured on the membrane 42. If the detected fluorescence is below a particular threshold, the sample is deemed normal. If the detected fluorescence is substantially above the threshold, the sample is believed to be abnormal and is tagged for diagnostic cytology examination. Finally, if the sample reads near the threshold, the sample is equivocal and is also referred for diagnostic cytology evaluation.

Alternatively, once the membrane 42 has been loaded with cellular material, it can also be examined optically by using, for example, a video microscope to visually inspect the sample. This is of course well known to those of skill in the art.

While the invention has been described with reference to specific embodiments, it will be apparent to those skilled in the art that many alternatives, modifications and variations may be made. Accordingly, the present invention is intended to embrace all such alternatives, modifications and variations that may fall within the spirit and scope of the appended claims.

WE claim:

1. A method of optically analyzing a cellular sample, the method comprising steps of:
providing a cell suspension comprising cells in a solution;
passing the cell suspension solution through a filter, thereby capturing cells on a surface of the filter; and
examining the captured cells by analyzing the cells optically while the cells remain in place on the surface of the filter.

2. The method of claim 1, further comprising contacting the captured cells with one or more appropriate fixative solutions.

3. The method of claim 1, further comprising contacting the captured cells with one or more reagents that optically and selectively identify potentially abnormal cells.

4. The method of claim 1, wherein the step of providing a cell suspension comprises providing a volume of cell suspension that will yield an adequate quantity of captured cells.

5. The method of claim 1, wherein the cells that are captured on the surface of the filter are suitable for subsequent processing steps.

6. The method of claim 1, wherein the step of examining the captured cells comprises analyzing the captured cells via intrinsic fluorescence.

7. The method of claim 1, wherein the step of examining the captured cells comprises analyzing the captured cells via extrinsic fluorescence.

8. The method of claim 7, wherein the extrinsic fluorescence results from applying one or more reagents that preferentially fluoresces to identify potentially abnormal cells.

9. The method of claim 1, wherein the step of examining the captured cells comprises analyzing the captured cells via at least one of absorbance and reflectance.

10. The method of claim 1, wherein the step of examining the captured cells comprises analyzing the captured cells via fluorescence anisotropy.

11. The method of claim 1, wherein the step of passing the cell suspension solution through a filter comprises pulling the cell suspension solution through the filter by applying a vacuum on a side of the filter opposite a side of the filter in contact with the cell suspension.

12. The method of claim 1, wherein the step of passing the cell suspension solution through a filter comprises pushing the cell suspension solution through the filter by applying a positive pressure to the cell suspension.

13. The method of claim 1, wherein the step of passing the cell suspension solution through a filter comprises passing the cell suspension laterally across a surface of the filter.

14. The method of claim 1, wherein the step of passing the cell suspension solution through a filter comprises transferring the cell suspension onto a filter and pulling the cell suspension solution through the filter by providing an absorbent material sufficient to absorb at least some of the cell suspension solution.

15. The method of claim 14, wherein the absorbent material is sufficient to absorb substantially all of the cell suspension solution.

16. A triage device for capturing and optically analyzing cells found in a cell suspension, the triage device comprising, sequentially:
a sample well configured to hold the cell suspension;
a membrane filter comprising a thin plastic filter having pores that are sized to accommodate the cell suspension;
a fluid flow control layer that limits fluid velocity through the triage device; and
a bulk absorbing layer.

17. The triage device of claim 16, wherein the sample well is configured to hold a volume of cell suspension sufficient to provide an adequate sample.

18. The triage device of claim 16, wherein cells captured on a surface of the membrane filter are suitable for subsequent processing steps.

19. The triage device of claim 16, wherein the bulk absorbing layer absorbs cell suspension solution from the cell suspension.

20. The triage device of claim 16, wherein the bulk absorbing layer removes sufficient cell suspension solution to leave captured cells nominally dry.

21. The triage device of claim 16, wherein the membrane filter comprises a filter having pores that are between about 5 and 10 microns in diameter.

22. The triage device of claim 16, wherein the fluid flow control layer is modified to adjust fluid flow rate to account for the cell suspension viscosity.

23. The triage device of claim 16, wherein the fluid flow control layer comprises high density filter paper having a thickness of about 1 millimeter.

24. The triage device of claim 16, wherein the fluid flow control layer comprises a nonwoven synthetic material.

25. A triage kit for capturing and optically analyzing cells found in a cell suspension, the triage kit comprising:
a triage device comprising:
a sample well configured to hold the cell suspension;
a membrane filter comprising a thin plastic filter having pores that are sized to accommodate the cell suspension;
a fluid flow control layer that limits fluid velocity through the triage device; and
a bulk absorbing layer;
cell fixative; and
a reagent to preferentially indicate potentially abnormal cells.

26. The triage kit of claim 25, wherein the reagent preferentially fluoresces to identify potentially abnormal cells.

27. The triage kit of claim 25, wherein the reagent permits analysis of captured cells via at least one of absorbance, reflectance and fluorescence anisotropy.

28. The triage kit of claim 25, wherein the sample well is configured to hold a volume of cell suspension sufficient to provide an adequate sample.

29. The triage kit of claim 25, wherein cells captured on a surface of the membrane filter are suitable for subsequent processing steps.

30. The triage kit of claim 25, wherein the bulk absorbing layer absorbs cell suspension solution from the cell suspension.

31. The triage kit of claim 25, wherein the bulk absorbing layer removes sufficient cell suspension solution to leave captured cells nominally dry.

32. The triage kit of claim 25, wherein the membrane filter comprises a filter having pores that are between about 5 and 10 microns in diameter.

33. The triage kit of claim 25, wherein the fluid flow control layer is modified to adjust fluid flow rate to account for the cell suspension viscosity.

34. The triage kit of claim 25, wherein the fluid flow control layer comprises high density filter paper having a thickness of about 1 millimeter.

35. The triage kit of claim 25, wherein the fluid flow control layer comprises a nonwoven synthetic material.
